(19) United States
(12) Patent Application Publication
(10) Pub. No.: US 2003/0035519 A1
(43) Pub. Date: Feb. 20, 2003

(54) Methods and apparatus for accessing web content from a wireless telephone

(76) Inventor: James L. Warmus, LaGrange, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/218,546

(22) Filed: Aug. 14, 2002

Related U.S. Application Data
(60) Provisional application No. 60/312,478, filed on Aug. 15, 2001.

(51) Int. Cl. H04M 1/64

(52) U.S. Cl. 379/88.17

(57) ABSTRACT

A system for accessing web content from a wireless telephone is disclosed. A consumer first speaks with an operator who performs a database query which causes a personal WAP page to be created. The personal WAP page is accessed by the wireless telephone in a straight forward manner, because the network address associated with the personal WAP page does not change from one query to the next. In this manner, very few manual inputs are required by the consumer.

### RELATED APPLICATION

This application claims priority from U.S. provisional patent application Serial No. 60/312,478 filed Aug. 15, 2001.

### TECHNICAL FIELD

The present invention relates in general to wireless communications and, in particular, to methods and apparatus for accessing web content from a wireless telephone.

### BACKGROUND

Due to the limited user interface of small electronic devices, accessing web content from a portable electronic device is cumbersome. For example, entering text to indicate a web address or initiate a search query is difficult due to small keyboards. Not only are the keys of most portable electronic devices physically smaller than a typical personal computer keyboard, but the number of keys is also limited. Most portable electronic devices do not have a full alpha keyboard. Similarly, displaying hyperlinks is limited by small screen sizes, and selecting hyperlinks is limited when a touch screen is not available. These problems are compounded when additional symbols are required (e.g., Chinese characters).

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is a high level block diagram of a communications system illustrating an exemplary environment of use.

FIG. 2 is an exemplary block diagram of one of the wireless telephones illustrated in FIG. 1.

FIG. 3 is an exemplary block diagram of one of the servers illustrated in FIG. 1.

FIG. 4 is a flowchart of an exemplary process for accessing web content from a wireless telephone.

FIG. 5 is an exemplary block diagram of the directory server illustrated in FIG. 1.

### DETAILED DESCRIPTION OF EXEMPLARY EMBODIMENTS

In general, the system described herein allows a user to access web content from a wireless telephone. A consumer first speaks with an operator who performs a database query which causes a personal web page (such as a WAP page, an iMode page, a cHTML page, etc.) to be created. The personal WAP page is accessed by the wireless telephone in a straight forward manner, because the network address associated with the personal WAP page does not change from one query to the next. In this manner, very few manual inputs are required by the consumer.

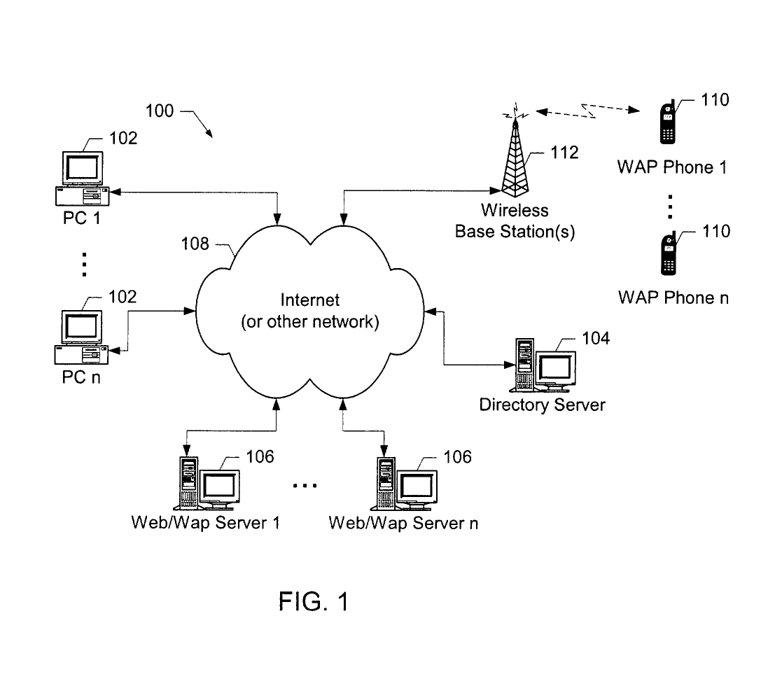

A high level block diagram of an exemplary network communications system 100 is illustrated in FIG. 1. Typically, the system 100 includes one or more personal computers 102, one or more directory servers 104, and one or more Web/WAP servers 106. Each of these devices may communicate with each other via a connection to the Internet or some other wide area network 108. In addition, a plurality of consumers connect to the network communications system 100 using web enabled wireless telephones 110. For example, a cellular telephone equipped with the wireless application protocol (WAP) standard may be used. Preferably, each web enabled wireless telephone 110 connects to the network via a wireless base station 112. Of course, any web enabled device 110 may be used. For example, a wired web phone, a wired or wireless personal digital assistant (PDA), etc.

Typically, directory servers 104 store a plurality of telephone directory information for use by the wireless telephones 110 and the PCs 102. For example, the directory server 104 may store an electronic yellow pages including the name, address, telephone, number, heading, etc., of a plurality of businesses. In addition, directory servers 104 may store a plurality of files, programs, and/or web/WAP pages for use by devices connected to the network 108. One directory server 104 may handle requests from a large number of devices 102, 110. Accordingly, each directory server 104 is typically a high end computer with a large storage capacity, one or more fast microprocessors, and one or more high speed network connections. Conversely, relative to a typical server 104, each personal computer 102 and each wireless telephone 110 typically includes less storage capacity, a single microprocessor, and a single network connection.

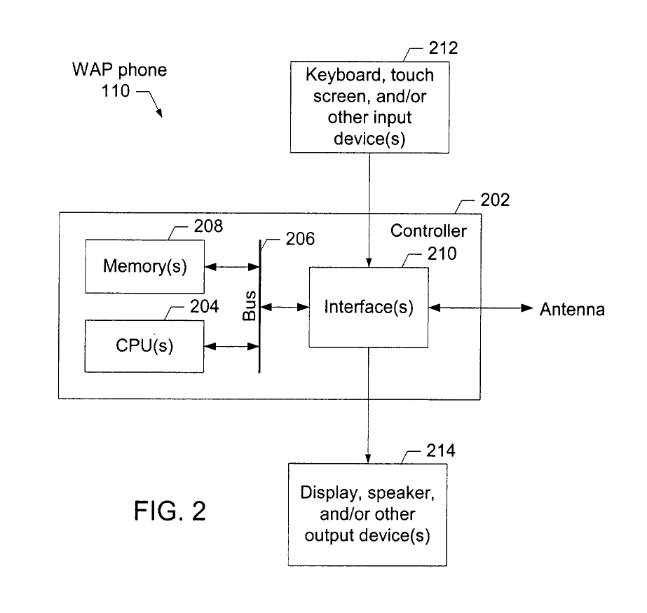

A more detailed block diagram of an exemplary wireless telephone 110 is illustrated in FIG. 2. Preferably, the wireless telephone 110 includes a controller 202 which preferably includes a central processing unit 204 electrically coupled by an address/data bus 206 to a memory device 208 and an interface circuit 210. The CPU 204 may be any type of well known CPU. The memory device 208 preferably includes volatile memory and non-volatile memory. Preferably, the memory device 208 stores a software program that interacts with the directory server 104 and WAP sites 106 as described below. This program may be executed by the CPU 204 in a well known manner. The memory device 208 may also store digital data indicative of directory entries, network addresses, documents, files, programs, WAP pages, etc. retrieved from a server 104, 106 and/or loaded via an input device 212.

The interface circuit 210 may be implemented using any type of well known interface standard. One or more input devices 212 may be connected to the interface circuit 210 for entering data and commands into the controller 202. For example, the input device 212 may be a keyboard and/or touch screen.

One or more displays, speakers, and/or other output devices 214 may also be connected to the controller 202 via the interface circuit 210. The display 214 may be a liquid crystal displays (LCD), or any other type of display. The display 214 generates visual displays of data generated during operation of the wireless telephone 110. The display 214 is typically used to display WAP pages received from the network 108 and local telephone directory information. The visual displays may include prompts for human operator input, calculated values, detected data, etc.

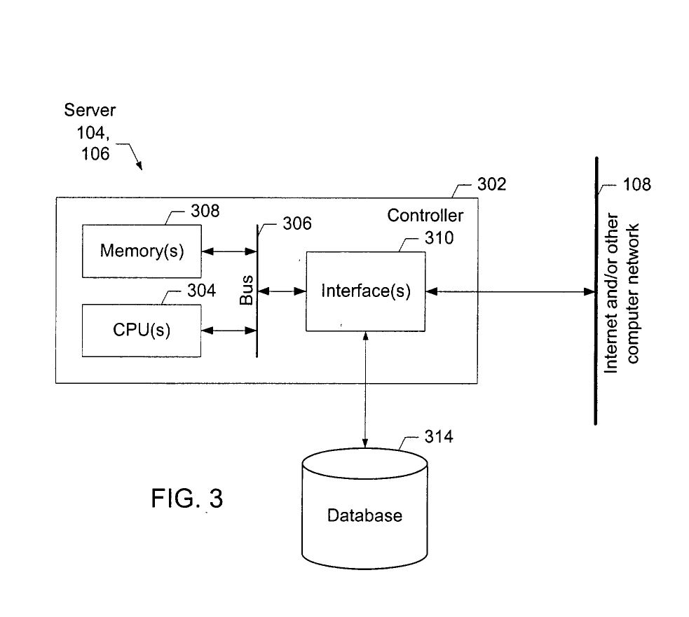

A more detailed block diagram of a server 104, 106 is illustrated in FIG. 3. The controller 302 in the server 104 preferably includes a central processing unit 304 electrically coupled by an address/data bus 306 to a memory device 308 and a network interface circuit 310. The CPU 304 may be any type of well known CPU, such as an Intel PentiumTM processor, and the memory device 308 preferably includes volatile memory and non-volatile memory. Preferably, the memory device 308 stores a software program that implements all or part of the method described below. This program may be executed by the CPU 304 in a well known manner. However, some of the steps described in the method below may be performed manually or without the use of the server 104. The memory device 308 and/or a separate database 314 also store files, programs, web pages, etc. for use by servers 104, 106 and/or the wireless telephones 110.

The server 104 may exchange data with other devices via a connection to the network 108. The network interface circuit 310 may be implemented using any data transceiver, such as an Ethernet transceiver. The network 108 may be any type of network, such as a local area network (LAN) and/or the Internet. In one embodiment, the interface circuit 310 includes a telephone receiver.

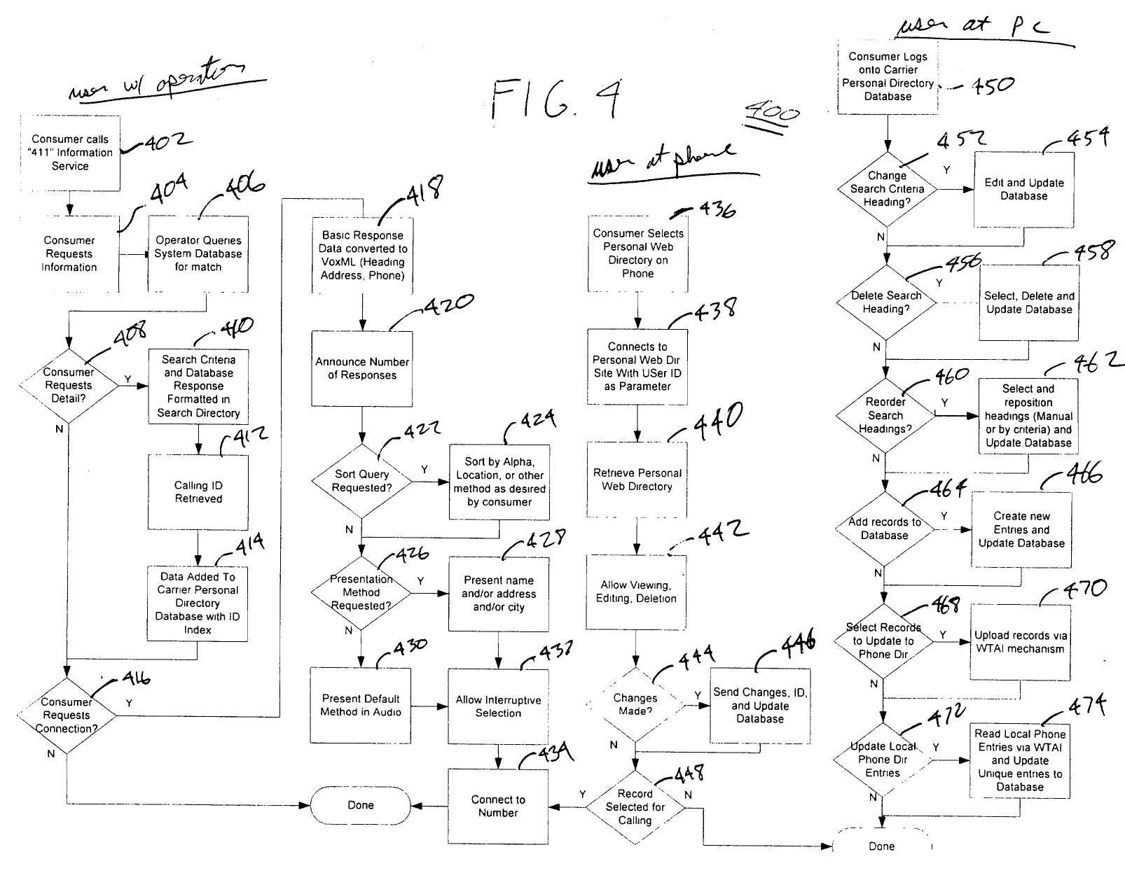

A flowchart of a process 400 for accessing web content from a wireless telephone 110 is illustrated in FIG. 4. The steps of the process 400 may be performed manually and/or by one or more devices. Although the process 400 is described with reference to the flowchart illustrated in FIG. 4, a person of ordinary skill in the art will readily appreciate that many other methods of performing the acts associated with process 400 may be used. For example, the order of many of the steps may be changed without departing from the scope or spirit of the present invention. In addition, many of the steps described are optional.

Generally, the process 400 allows a consumer to easily access directory information and other web content from a wireless telephone 110. The consumer first speaks with an operator who performs a database query which causes a personal WAP page to be created. The personal WAP page is accessed by the wireless telephone 110 in a straight forward manner, because the network address associated with the personal WAP page does not change from one query to the next. In this manner, very few manual inputs are required by the consumer.

The process 400 begins when the consumer places a voice call to a “411” information service using a wireless telephone 110 (step 402). Of course, any predetermined telephone number may be used. Once connected to an operator, the consumer requests certain information (step 404). For example, the consumer may be looking for a nearby restaurant. In order to localize the consumer's request, the consumer may inform the operator of his current location. Alternatively, the wireless telephone 110 may be equipped with a Global Positioning System (GPS) receiver. In such an instance, the wireless telephone 110 may automatically report the consumer's current location to the directory server 104.

The operator then queries a system database containing directory information (step 406). In addition, the operator may use traditional web search tools to locate web sites designed for wireless applications (e.g., WAP sites). If the consumer requests a detailed report (step 408), the search results are formatted for use by the wireless telephone 110 (step 410), the identification number of the wireless telephone 110 is retrieved from the wireless telephone 110 or from local memory 308 or from switching network data (e.g., caller ID) (step 412), and the formatted search results are added to a personal WAP site associated with the wireless telephone 110 identification number (step 414). For example, if the consumer's carrier is Verizon, and the consumer's wireless telephone number is 123-456-7890, the personal WAP site may be located at verizon.com/1234567890. Alternatively, search results may be downloaded directly to a directory stored in the wireless telephone memory 208. For example, a wireless transfer application interface (WTAI) mechanism may be used to downloaded search results directly to a wireless telephone directory. The consumer may request a detailed report by responding to an audio prompt, responding to a text prompt, selecting a setup option, by default, etc.

If the consumer requests a voice connection (step 416), the basic response data are preferably converted to a voice markup language (e.g., VoxML) (step 418). As with all requests described herein, the consumer may request a voice connection by responding to an audio prompt, responding to a text prompt, selecting a setup option, by default, etc. Preferably, the directory server 104 then transmits an audio announcement to the wireless telephone 110 informing the consumer of the number of records retrieved (step 420). Of course, any hybrid visual/audio interface may also be used.

If the consumer prefers the search results to be sorted in a particular manner (step 422), the search results are sorted accordingly (step 424). If the consumer prefers the search results to be presented in a particular manner (step 426), the search results are reformatted accordingly (step 428). For example, the consumer may prefer to review just names and addresses sorted by name. If no presentation requests are received from the consumer, a default presentation is used (step 430).

Preferably, the directory server 104 then transmits a series of audio announcements to the wireless telephone 110 informing the consumer of each search result. The consumer may interrupt the series of audio announcements to select one of the directory entries (step 432). When the consumer selects a directory entry, the consumer is preferably connected to the corresponding telephone number for a voice call (step 434).

If the consumer added the search results to a personal WAP site (step 414), the consumer may subsequently browse the personal WAP site from a web enabled telephone 110. Preferably, the consumer selects the personal WAP site from a directory stored in the web enabled telephone 110 (step 436). For example, the consumer may select a bookmark stored in the web enabled telephone 110 which points to verizon.com/1234567890. Subsequently, the web enabled telephone 110 connects to the personal WAP site (step 438) and retrieves the stored search results (step 440). Preferably, the consumer may view, edit, and delete the search results stored at the personal WAP site using the web enabled telephone 110. If changes are made to the personal WAP site (step 444), the changes are transmitted back to the WAP site server 106 (step 446). If a stored record is selected from the personal WAP site or from a local directory (step 448), the consumer is preferably connected to the corresponding telephone number for a voice call (step 434).

In addition to browsing and editing the personal WAP site from a web enabled telephone 110, the consumer may use a personal computer 102 to access the personal WAP site (step 450). Once logged on, the consumer may change search criteria headings (steps 452 and 454), delete search headings (steps 456 and 458), reorder search headings (steps 460 and 462), add records to the WAP site database (steps 464 and 466), copy records from the WAP site to the wireless telephone's local directory (steps 468 and 470), and/or copy records from the wireless telephone's local directory to the WAP site (steps 472 and 474). For example, using a PC interface, the consumer may go to the personal WAP site, change an existing heading from “restaurants” to “seafood restaurants,” delete the non-seafood restaurants from the list, move the “seafood restaurants” to the top of the headings, add a seafood restaurant that was not previously included in the list, and download the entire list to his local telephone directory.

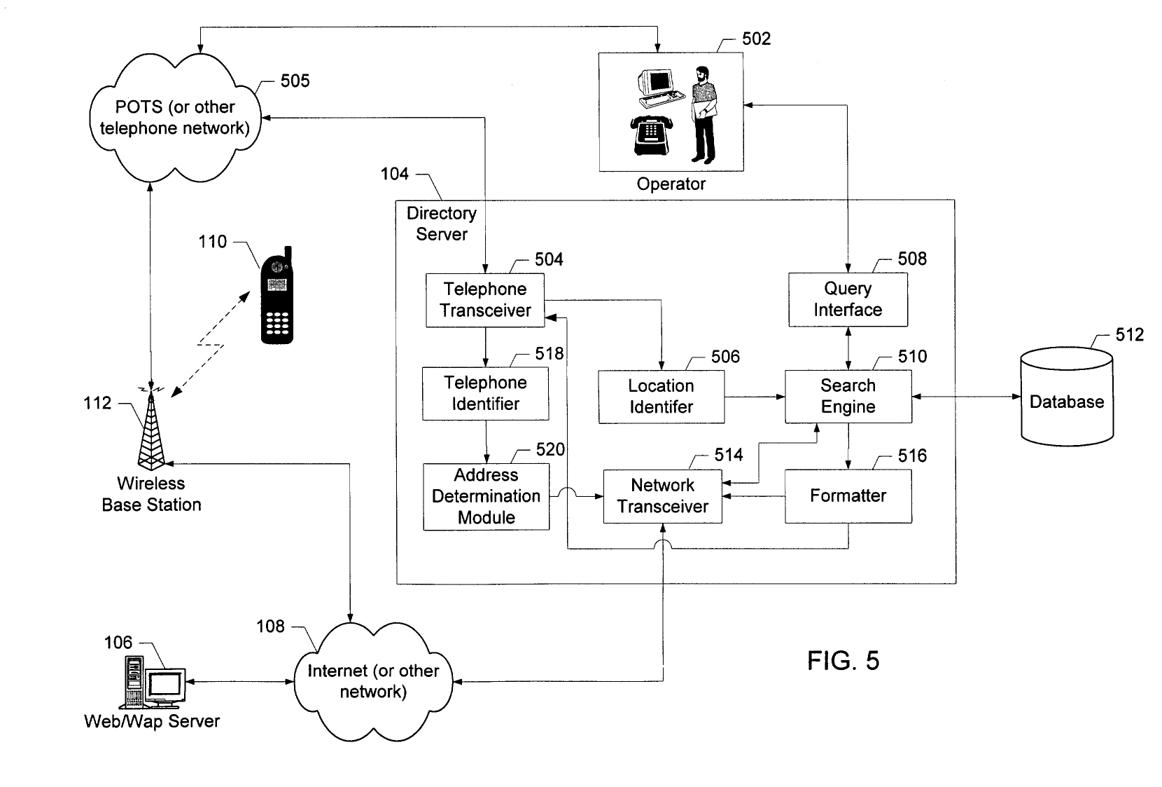

A more detailed block diagram of another embodiment of the directory server 104 is illustrated in FIG. 5. In this embodiment, the directory server 104 includes a plurality of interconnected modules 504-520. Each of the modules may be implemented by a microprocessor executing software instructions and/or conventional electronic circuitry. In addition, a person of ordinary skill in the art will readily appreciate that certain modules may be combined or divided according to customary design constraints.

The directory server 104 facilitates web searching by wireless telephone users with the assistance of an operator 502. For the purpose of receiving call signals and establishing voice connections between users at wireless telephones 110 and operators 502 at call centers, the directory server 104 includes a telephone transceiver 504. Preferably, the telephone transceiver 504 is operatively coupled to a telephone network 505 and/or the Internet (or other computer network) 108 in a well known manner. The telephone transceiver 504 receives voice and/or data signals from one or more wireless telephones 110. Voice signals passed between the wireless telephone 110 and the operator 502 may include voice based queries, location information, and/or telephone identification information. A voice based query is any request one person may verbally make of another person. Location information is information which describes a geographical location, such as a postal zip code, a telephone area code, a street name, a street address, and/or a nearby business name. For example, the user of the wireless telephone 110 may indicate he is located near the intersection of street A and street B and that he would like information on nearby restaurants specializing in seafood.

Location information may also be determined automatically based on geographic location data received from the wireless telephone 110. For the purpose of decoding geographic location data, the directory server 104 includes a location identifier 506. The location identifier 506 is operatively coupled to the telephone transceiver 504. The location identifier 506 parses data received from the wireless telephone 110 for specific geographic location data such as global position system (GPS) data. Location information may be used to narrow a database search.

Once the operator 502 understands the type of information the user is searching for and possibly the user's geographic location, the operator 502 may perform a computer based query. For the purpose of receiving a computer based query from the operator, which is related to the voice based query from the user, the directory server 104 includes a query interface 508. The query interface 508 may be any type of well known interface. For example, the operator 502 may enter search commands into a computer, the operator 502 may enter a Boolean text string into a web page, the operator 502 may select hyperlinks to navigate a directory structure, and/or the operator 502 may select predetermined responses (e.g., “canned” responses such as “seafood restaurants in Chicago”).

For the purpose of processing the operator's query and receiving reply data, the directory server 104 includes a search engine 510. The search engine 510 is operatively coupled to the query interface 508. The search engine 510 may request/receive reply data from a proprietary database 512 and or some other device connected to the network 108 via a network transceiver 514. The reply data may be in any format such as hypertext markup language (HTML), wireless markup language (WML), extensible markup language (XML), compact hypertext markup language (cHTML), IMode, text, etc. The format of the reply data may or may not be compatible with the wireless telephone 110.

For the purpose of generating search results which are formatted for the wireless telephone 110, the directory server 104 includes a formatter 516. The formatter 516 is operatively coupled to the search engine 510 and the network transceiver 514. The formatter 516 transforms the reply data into formatted search results in a well known manner. For example, if the replay data includes a list of phone numbers for display on a wireless telephone 110, the formatter 516 may include the list of phone numbers in a WML or WAP page.

The formatted search results may then be transmitted from the formatter 516 to a Web/WAP server 106 over the network 108 via the network transmitter 514. Similarly, the formatted search results may be transmitted from the formatter 516 to the wireless telephone 110 for storage in the wireless telephone memory 208. For example, a wireless transfer application interface (WTAI) mechanism may be used to store phone numbers in the wireless telephone memory 208 in a well known manner. In addition, the formatter 516 may generate voice response such as voice markup language (VoxML) pages. Voice responses may be transmitted from the formatter 516 to the wireless telephone 110 via the telephone transceiver 504.

The network transceiver 514 is an input/output device for communicating with other devices on the network 108. The network transceiver 514 is operatively coupled to the network 108 in a well known manner. For example, the network transceiver 514 may be an Ethernet interface circuit electrically coupled to the Internet via an Ethernet cable. The network transceiver 514 may transmit and/or receive database queries, formatted search results, geographic location data, personal network addresses, reply data, wireless telephone identification codes, web pages, and/or any other type of digital data.

For the purpose of receiving an identification code from the wireless telephone 110, the directory server 104 includes a telephone identifier 518. The telephone identifier 518 is operatively coupled to the telephone transceiver 504. Preferably, the identification code uniquely identifies the wireless telephone 110. For example, the identification code may be a phone number of the wireless telephone, a serial number of the wireless telephone, and/or a network address of the wireless telephone. In one embodiment, the telephone identifier 518 receives the phone number of the wireless telephone using well known caller identification (i.e., caller ID) and/or automatic number identification (ANI) methods. In another embodiment, the telephone identifier 518 receives the serial number of the wireless telephone as part of normal wireless telephone call setup and/or billing processes. In yet another embodiment, the telephone identifier 518 receives the network address of the wireless telephone as part of a data portion of the call signal.

For the purpose of determining a personal network address based on the identification code, the directory server 104 includes a address determination module 520. The address determination module 520 is operatively coupled to the telephone identifier 518. A personal network address is a network address where digital content that is private to the user is located. The digital content at the personal network address is accessible from a wireless telephone 110 or a PC 102. Preferably, each personal network address is unique to a particular wireless telephone 110 or user. In one embodiment, the address determination module 520 uses the telephone identification code to look up the personal network address in a previously established look up table in memory. In another embodiment, the address determination module 520 uses the telephone identification code to generate the personal network address. In one embodiment, the telephone identification code may be combined with a predetermined network address portion. For example, if the telephone identification code is “1234567890” and the predetermined network address portion is “verizon.com”, the personal network address may be “verizon.com/1234567890”.

Once the personal network address is determined, the directory server 104 may store the formatted search results at the personal network address via the network transceiver 514 in a well known manner. New search results may replace old search results, or new search results may be concatenated to old search results. In one embodiment, search results are organized by date. Subsequently, the user of the wireless telephone 110 may retrieve the formatted search results from the personal network address.

In summary, persons of ordinary skill in the art will readily appreciate that a method and apparatus for accessing web content from a wireless telephone has been provided. Users of the disclosed system may access digital content from a wireless telephone using operator assisted voice requests and a predetermined network address. In this manner, complex search results may be received at the wireless telephone despite the limited user interface of the wireless telephone.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

What is claimed is:

1. A method of creating digital content for use by a wireless telephone, the method comprising the steps of:
receiving a call signal, the call signal establishing a voice connection between a user at the wireless telephone and an operator at a call center;
receiving a voice based query from the user via the voice connection;
receiving a database query related to the voice based query from the operator;
receiving reply data in response to the database query;
generating formatted search results by formatting at least a portion of the reply data for display on the wireless telephone;
receiving a wireless telephone identification code from the wireless telephone, the wireless telephone identification code uniquely identifying the wireless telephone;
determining a personal network address based on the wireless telephone identification code; and
storing the formatted search results at the personal network address.

2. A method as defined in claim 1, further comprising the step of storing additional search results at the personal network address by concatenating the additional search results with the formatted search results.

3. A method as defined in claim 1, further comprising the step of storing additional search results at the personal network address by replacing the formatted search results with the additional search results.

4. A method as defined in claim 1, further comprising the step of determining a geographic location associated with the wireless telephone.

5. A method as defined in claim 4, wherein the step of determining a geographic location associated with the wireless telephone comprises the step of receiving a location statement from a user speaking into the wireless telephone.

6. A method as defined in claim 5, wherein the step of receiving a location statement from a user speaking into the wireless telephone comprises the step of receiving at least one of a postal zip code, a telephone area code, a street name, and a street address.

7. A method as defined in claim 5, wherein the step of receiving a location statement from a user speaking into the wireless telephone comprises the step of receiving a business name.

8. A method as defined in claim 4, wherein the step of determining a geographic location associated with the wireless telephone comprises the step of receiving geographic location data.

9. A method as defined in claim 8, wherein the step of receiving geographic location data comprises the step of receiving data derived from a global positioning system (GPS) receiver.

10. A method as defined in claim 8, wherein the step of receiving geographic location data comprises the step of receiving data entered by the user.

11. A method as defined in claim 1, wherein the step of generating formatted search results comprises the step of formatting at least a portion of the reply data in a wireless application protocol (WAP) format.

12. A method as defined in claim 1, wherein the step of generating formatted search results comprises the step of formatting at least a portion of the reply data in a wireless markup language (WML) format.

13. A method as defined in claim 1, wherein the step of generating formatted search results comprises the step of formatting at least a portion of the reply data in at least one of an XML, HTML, cHTML, and IMode format.

14. A method as defined in claim 1, wherein the step of receiving a wireless telephone identification code from the wireless telephone comprises the step of receiving a phone number of the wireless telephone.

15. A method as defined in claim 1, wherein the step of receiving a wireless telephone identification code from the wireless telephone comprises the step of receiving a serial number of the wireless telephone.

16. A method as defined in claim 1, wherein the step of receiving a wireless telephone identification code from the wireless telephone comprises the step of receiving a network address of the wireless telephone.

17. A method as defined in claim 1, wherein the step of determining a personal network address based on the wireless telephone identification code comprises the step of combining at least a portion of the wireless telephone identification code with a predetermined network address portion.

18. A method as defined in claim 17, wherein the step of receiving a wireless telephone identification code from the wireless telephone comprises the step of receiving a phone number of the wireless telephone.

19. A method as defined in claim 17, wherein the step of receiving a wireless telephone identification code from the wireless telephone comprises the step of receiving a serial number of the wireless telephone.

20. A method as defined in claim 17, wherein the step of receiving a wireless telephone identification code from the wireless telephone comprises the step of receiving a network address of the wireless telephone.

21. A method as defined in claim 1, wherein the step of determining a personal network address based on the wireless telephone identification code comprises the step of retrieving at least a portion of the personal network address from memory based on the wireless telephone identification code.

22. A method as defined in claim 21, wherein the step of receiving a wireless telephone identification code from the wireless telephone comprises the step of receiving a phone number of the wireless telephone.

23. A method as defined in claim 21, wherein the step of receiving a wireless telephone identification code from the wireless telephone comprises the step of receiving a serial number of the wireless telephone.

24. A method as defined in claim 21, wherein the step of receiving a wireless telephone identification code from the wireless telephone comprises the step of receiving a network address of the wireless telephone.

25. A method as defined in claim 1, wherein the step of storing the formatted search results at the personal network address comprises the step of storing a web page structured for retrieval by the wireless telephone via the Internet.

26. A method as defined in claim 1, wherein the step of storing the formatted search results at the personal network address comprises the step of storing the formatted search results in a memory in the wireless telephone.

27. A method as defined in claim 26 wherein the step of storing the formatted search results in a memory in the wireless telephone comprises the step of storing the formatted search results via a wireless transfer application interface (WTAI) mechanism.

28. A method as defined in claim 1, further comprising the step of converting at least a portion of the reply data to a voice markup language.

29. A method as defined in claim 1, further comprising the step of connecting the wireless telephone to a phone number included in the reply data in response to a voice command from the user.

30. A method as defined in claim 1, further comprising the step of connecting the wireless telephone to a phone number included in the reply data in response to a command from the user received at the at the personal network address.

31. A method as defined in claim 1, further comprising the step of receiving editing instructions from a personal computer, the editing instructions modifying the formatted search results at the at the personal network address.

32. A method as defined in claim 1, further comprising the steps of:
receiving an additional wireless telephone identification code from an additional wireless telephone, the additional wireless telephone identification code uniquely identifying the additional wireless telephone; and
determining the personal network address based on the additional wireless telephone identification code;

33. A method of storing different search results at the same network address for retrieval by a wireless telephone, the method comprising the steps of:
receiving a first call signal, the first call signal establishing a first voice connection between a user at the wireless telephone and a first operator at a call center;
receiving a first voice based query from the user via the first voice connection;
receiving a first database query related to the first voice based query from the first operator;
receiving first reply data in response to the first database query;
generating first formatted search results by formatting at least a portion of the first reply data for display on the wireless telephone;
receiving a wireless telephone identification code from the wireless telephone, the wireless telephone identification code uniquely identifying the wireless telephone;
determining a personal network address based on the wireless telephone identification code;
storing the first formatted search results at the personal network address;
receiving a second call signal, the second call signal establishing a second voice connection between the user at the wireless telephone and a second operator, the second voice connection being different than the first voice connection, the second operator being different than the first operator;
receiving a second voice based query from the user via the second voice connection;
receiving a second database query related to the second voice based query from the second operator;
receiving second reply data in response to the second database query;
generating second formatted search results by formatting at least a portion of the second reply data for display on the wireless telephone, the second formatted search results being different than the first formatted search results;
receiving the wireless telephone identification code from the wireless telephone;
determining the personal network address based on the wireless telephone identification code; and
storing the second formatted search results at the personal network address.

34. An apparatus for generating digital content for use by a wireless telephone, the apparatus comprising:
a telephone receiver structured to establish a voice connection between a user at the wireless telephone and an operator at a call center;
a telephone identifier operatively coupled to the telephone receiver, the telephone identifier structured to receive an identification code from the wireless telephone, the identification code uniquely identifying the wireless telephone;
an address determination module operatively coupled to the telephone identifier, the address determination module being structured to determine a personal network address based on the identification code, the personal network address being accessible from the wireless telephone;
a query interface structured to receive a text based query from the operator;
a search engine operatively coupled to the query interface, the search engine being structured to retrieve reply data from a database in response to the text based query; and
an output device operatively coupled to the search engine and the address determination module, the output device being structured to cause at least a portion of the reply data to be stored at the personal network address.

35. An apparatus as defined in claim 34, further comprising a formatter operatively coupled to the search engine, the formatter being structured to format the reply data for display on the wireless telephone.

36. An apparatus as defined in claim 35, wherein the formatter is structured to format the reply data in a wireless application protocol (WAP) format.

37. An apparatus as defined in claim 35, wherein the formatter is structured to format the reply data in a wireless markup language (WML) format.

38. An apparatus as defined in claim 34, further comprising a location identifier operatively coupled to the telephone receiver and the search engine, the location identifier being structured to receive geographic location data from the wireless telephone, the search engine being structured to narrow the reply data from the database based on the geographic location data.

39. An apparatus as defined in claim 38, wherein the search engine is structured to narrow the reply data from the database based on global positioning system (GPS) data.

40. An apparatus for generating digital content for use by a wireless telephone, the apparatus comprising:
a telephone receiver;
a digital output;
a microprocessor in communication with the telephone receiver and the digital output; and
a memory device in communication with the microprocessor, the memory device storing a software program capable of being executed by the microprocessor, the software program being structured to cause the microprocessor to:
detect a call signal from a telephone, the call signal including a voice portion and a data portion;
establish a voice connection between a user at the telephone and an operator at a call center;
determine a telephone identification code from the data portion, the telephone identification code uniquely identifying the telephone;
determine a personal network address associated with the telephone identification code;
receive a database query from the operator;
retrieve reply data in response to the database query;
generate formatted search results by formatting at least a portion of the reply data for display on the telephone; and
store the formatted search results at the personal network address via the digital output.

41. An apparatus as defined in claim 40, wherein the software program is structured to cause the microprocessor to combine at least a portion of the telephone identification code with a predetermined network address portion to determine the personal network address associated with the telephone identification code.

42. An apparatus as defined in claim 40, wherein the software program is structured to cause the microprocessor to determine a geographic location associated with the telephone from the data portion.

43. An apparatus as defined in claim 42, wherein the software program is structured to cause the microprocessor to narrow the formatted search results based on the determined geographic location.
